(19) United States
(12) Patent Application Publication
(10) Pub. No.: US 2019/0302569 A1
(43) Pub. Date: Oct. 3, 2019

(54) MULTI-MODE ILLUMINATION OF SURFACE ACOUSTIC WAVE MODULATOR

(71) Applicant: The Charles Stark Draper Laboratory, Inc., Cambridge, MA (US)

(72) Inventors: Gregg E. Favalora, Bedford, MA (US); Michael G. Moebius, Somerville, MA (US); Joy C. Perkinson, Cambridge, MA (US); Dennis M. Callahan, Wellesley, MA (US); Steven J. Byrnes, Watertown, MA (US); Ian W. Frank, Arlington, MA (US)

(21) Appl. No.: 15/940,079

(22) Filed: Mar. 29, 2018

(51) Int. Cl. G02F 1/335

(52) U.S. Cl. CPC G02F 1/335; G02F 2201/302; G02F 2203/22

(57) ABSTRACT

There can be a problem of output intensity node or nodes as a function of angle, for waveguide-based optical modulators, such as leaky-mode surface acoustic wave modulators. Several approaches are illustrated that can be used to provide more uniform output light across a range of angles, i.e., that is avoid dark “drop-outs.” It can also be used to increase the output angle range or exit light fan. This is achieved by leveraging the different diffraction characteristics between different guided modes. It exploits the observation that utilizing different waveguide guided modes, e.g. TE0 like versus TE1-like, causes a SAW optical modulator to operate with different relationships between output angle and output intensity. It turns out that they can be at least complementary, that is: one waveguide mode can fill in the dark gaps of another wave guide mode.

### BACKGROUND OF THE INVENTION

Light field generation such as electro-holography has applications in fields as diverse as: three-dimensional display (near-eye/virtual reality (VR)/augmented reality (AR)/mixed reality (MR), handheld, desktop, cockpit, immersive), camouflage, microscopy, LIDAR, three-dimensional (3-D) printing, and neuro-stimulation, to list some examples.

A promising approach to light field generation utilizes surface acoustic wave (SAW) optical modulators. See for example:
F. R. Gfeller and C. W. Pitt, “COUNEAR ACOUSTO-OPTIC DEFLECTION IN THIN FILMS,” Electronics Letters, Vol, 8, No. 22, pp. 549-551 (Nov. 2, 1972),
L. (Mural, G. Bozdagi, and A. Atsalar, “New high-resolution display device for holographic three-dimensional video: principles and simulations, “Optical Engineering, Vol. 33, No. 3, pp. 835-844 (March 1994).
C. S. Tasi, Q. Li, and L. Chang, “Guided-Wave Two-Dimensional Acousto-Optic Scanner Using Proton-Exchanged Lithium Niobate Waveguide, “Fiber and Integrated Optics, 17(3), 157-166 (1998).
A. M. Matteo, C. S. Tsai, and N. Do, “Collinear Guided Wave to Leaky Wave Acoustooptic Interactions in Proton-Exchanged. LiNbO3 Waveguides, “IEEE Trans. On Ultrasonics, Ferroelectrics, and Frequency Control, Vol. 47, No. 1, pp. 15-28 (January 2000).
D. E. Smalley, et al., “Progress on characterization and optimization of leaky-mode modulators for holographic video, J. Micro/Nanolith. MEMS MOEMS, 14(4), 041308 (October-December 2015),
S. McLaughlin, et al, “Progress on waveguide-based holographic video,” Chinese Optics Letters, 14(1), 010003 (Jan. 10, 2016).

As outlined in the published work, SAW modulators will typically include: a substrate (such as x-cut, y-propagating lithium niobate), an optical waveguide (implemented, by proton exchange or laser micromachining), a device for in-coupling illumination (such as a prism pressed against the modulator surface or a grating fabricated at the modulator surface), and surface transducers (such as interdigital transducers (IDTs)) for producing the SAW. In operation, a radio frequency (RF) signal is applied to a modulator's transducers, typically in the range of 300 MHz with a bandwidth of 50 MHz and a power in the range of 10-1,000 mW. This induces a SAW that propagates along the waveguide, or at some angle to the waveguide. Light within the modulator's waveguide is diffracted by the SAW and thereby transformed into a leaky mode. The angle at which the leaky mode propagates away from the guide is a function of the applied transducer drive frequency(ies) and the wavelength of the light (defined by free space wavelength of the light and the refractive index it is propagating through, when in a waveguide, this becomes the effective index of the guided mode).

### SUMMARY OF THE INVENTION

The invention can be used to solve the problem of output intensity node or nodes as a function of angle, for waveguide-based optical modulators, such as leaky-mode surface acoustic wave modulators. That is, it can be used to provide more uniform output light across a range of angles, i.e., to avoid dark “drop-outs.” This is achieved by leveraging the different diffraction characteristics between different guided modes. It can also be used to increase the output angle range or exit light fan.

In more detail, the invention can be used to exploit the observation that utilizing different waveguide guided modes, e.g. TE0-like versus TE1-like, causes a SAW optical modulator to operate with different relationships between output angle and output intensity. It turns out that they can be at least complementary, that is: one waveguide mode can fill in the dark gaps of another waveguide mode.

In general, according to one aspect, the invention features a SAW modulator system. It comprises one or more SAW modulators in which light in the waveguides of the SAW modulators propagates in at least two guided modes, the guided modes being selectively diffracted from the waveguides.

In some embodiments, light in each of the waveguides propagates in at least two Guided modes.

In other embodiments, the light propagates in at least two guided modes simultaneously.

In still other embodiments, the light propagates in at least two guided modes serially in time.

For example, the system can comprise multiple SAW modulators and different waveguides of the SAW modulators propagate different guided modes.

Typically, a controller is used that controls the delivery of drive signals to SAW transducers of the SAW modulators to improve a continuity of an exit light fan from the SAW modulators.

Different in-coupling devices can be used for delivering light to excite the at least two guided modes in the waveguides. One example is in-coupling prisms for receiving light at different angles to excite the at least two guided modes in the waveguides. Another example is in-coupling gratings. Here one or more gratings are provided for each of the waveguides, then different guided modes of the waveguide are excited using the grating(s).

In general, according to another aspect, the invention features a method for driving a SAW modulator system. The method comprises exciting different guided modes of waveguides of one or more SAW modulators and driving SAW transducers of the waveguides based on the guided modes propagating in the waveguides.

In general, according to another aspect, the invention features a surface acoustic wave (SAW) modulator system. It comprises a substrate, one or more waveguides in the substrate, in-coupling devices for coupling light into the waveguides so that different guided modes of the waveguides are excited, and SAW transducers for generating SAWs in the substrate. Finally, a controller is provided that controls the delivery of drive signals to SAW transducers. Specifically, the controller delivers those drive signals to SAW transducers based on the guided modes in the waveguides.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A shows proximal faces of two light field generator devices as might be included in a projector module with prism in-coupling devices;

FIG. 1B is a side view showing one of the light field generator devices, further showing the light propagating through one if its SAW modulators and exiting from the device, in an edge-fire configuration;

FIG. 2A shows proximal faces of two light field generator devices as might be included in a projector module with grating in-coupling devices;

FIG. 2B is a side view showing one of the light field generator devices illustrating the operation of the grating in-coupling device;

FIG. 3 shows wave vectors for air and guided modes and the field distributions of the guided modes;

FIG. 4 relates the diagram of FIG. 3 showing a partial side view of a SAW modulator schematically showing different guided modes propagating in its waveguide;

FIG. 5A depicts a wave vector diagram, in which the radii of the semicircles are proportional to the index of refraction (top: waveguide; bottom: leaky mode);

FIG. 5B is a plot of exit or deflection angle (θ) of the +1 diffracted order for the guided mode TE0 from the waveguide as a function of the frequency of the RF drive signal;

FIG. 6A depicts a wave vector diagram for guided modes TE0 and TE1;

FIG. 6B is a plot of exit or deflection angle (θ) of the +1 diffracted order for the guided modes TE0 and TE1 from the waveguide as a function of the frequency of the RF drive signal;

FIG. 7 is a datamap for an exemplary SAW modulator for TE1 guided mode;

FIG. 8 is a datamap for an exemplary SAW modulator for the TE0 guided mode;

FIG. 9 is a plot of intensity in arbitrary units as function of the angle of the exit light for that TE0 guided mode;

FIG. 10 is a plot of intensity in arbitrary units as function of the angle of the exit light for that TE1 guided mode;

FIG. 11A is a schematic datamap showing how the TE0 and TE1 modes could be exploited to provide an exit angle fan without dropout;

FIG. 11B is a plot of intensity in arbitrary units as function of the angle of the exit light for that TE1 guided mode;

FIG. 12 is a side view showing a light field generator device and one of its SAW modulators in which the waveguides are concurrently excited with more than one transverse mode by the controller module in order to reduce exit fan dropout, for example;

FIG. 13 is a top view showing a proximal face of a light field generator device with guided mode multiplexing;

FIG. 14A is a side view showing a light field generator device and one of its SAW modulators in which the waveguides are alternately excited with each of the modes TE0, TE1;

FIG. 14B is a plot showing the optical power in each of the guided modes TE0, TE1 in the waveguide 102 as a function of time;

FIGS. 15A and 15B are side views showing grating in-coupling devices for the SAW modulators to excite the waveguides with modes TE0, TE1, which are shown schematically.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem; is referred to and/or shown as being connected or coupled to another element, it can be directly connected or coupled to the other element or intervening elements may be present.

It will be understood that although terms such as “first,” “second,” etc. are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and will not be interpreted in an idealized or overly formal sense unless expressly so defined herein.

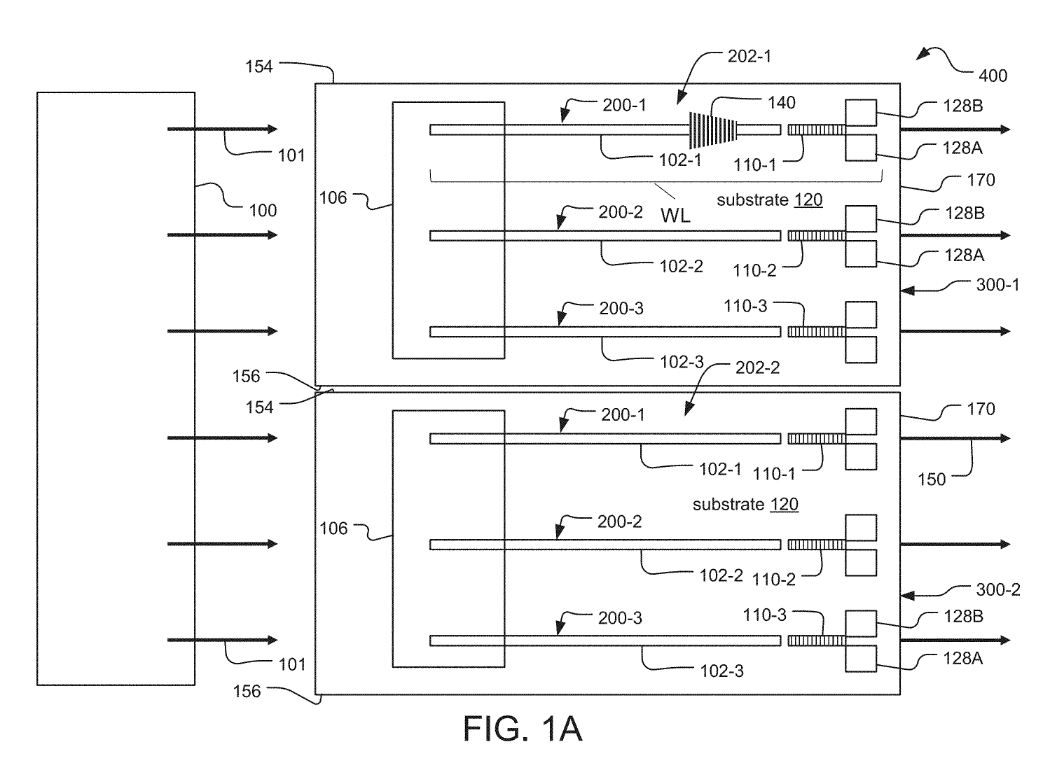

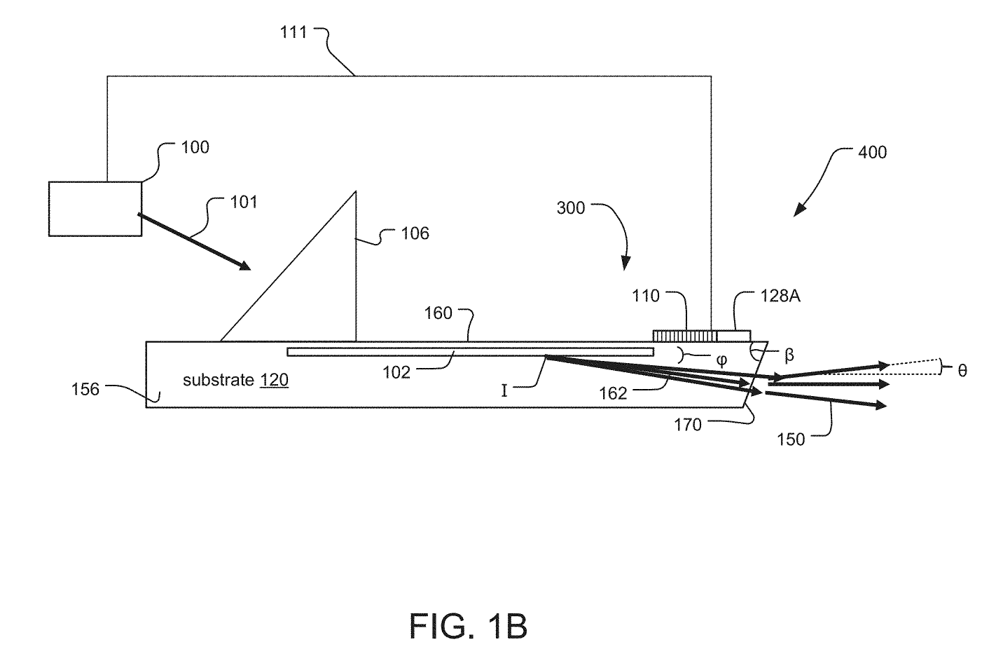

FIG. 1A shows a top view of two electro-holographic light field generator devices 300-1 and 300-2 as might be included in a light field projector module 400. They are located side by side with their proximal faces 160 extending parallel to the plane of the figure.

Each electro-holographic light field generator device 300-1, 300-2 comprises an array 202 of SAW devices or modulators 200. The SAW devices 200 are fabricated in piezoelectric, crystalline, SAW substrates 120-1 and 120-2, respectively. The longitudinal axes of each of these SAW modulators 200 extend parallel to each other, across each light field generator device 300. The side faces 156, 154 of the substrates 120-1 and 120-2, respectively, are adjacent to each other. In the specific illustrated embodiment, each light field generator device 300-1, 300-2 includes an array 202 of three (3), first, second and third, SAW devices 200-1, 200-2, 200-3

Of course, in other embodiments, usually larger numbers of SAW devices 200 are provided in each light field generator device 300 and/or in each SAW substrate 120. In a preferred embodiment, there are at least ten (10) such SAW devices 200 per each light field generator device 300/SAW substrate 120.

Each SAW substrate 120 may be made, for example, of lithium niobate. In the current embodiment, the SAW substrates 120 are x-cut, y-propagating, measuring 10 millimeters (mm) (in the direction of the waveguides 102)×5 mm (in a direction perpendicular to the waveguides 102, but in the plane of the figure)×1 mm (substrate 120 thickness). Many other materials and design choices are available, however, including other piezoelectric materials and crystallographic orientations, and waveguide architectures such as planar, ridge, rib, embedded, immersed, and bulged. Doping such as MgO-doped lithium niobate may be useful, in some cases.

Each SAW optical modulator 200 includes an in-coupling device 106 (e.g., in-coupling grating or prism), a waveguide 102 and a SAW transducer 110 (e.g., an interdigital transducer or IDT, for example).

In the illustrated embodiment, the in-coupling device 106 of each SAW modulator 200 is an in-coupling rutile prism. The grating 106 receives input light 101 generated from a control module 100, such as light in the visible range 390 to 700 nanometers (nm) or specifically 640 nm laser diode illumination at 5 milliWatts (mW), However, other implementations might use light in the infrared and/or ultraviolet.

There are other ways to couple light into the waveguides 102 of the substrates 120, however. These include butt-coupling to the pigtails, free-space illumination, and fiber or free-space coupling into an in-coupling prism.

In a typical design, the waveguides 102 provide confinement of the input light in a TE (transverse electric, E-field in the plane of the device) guided mode. In a current embodiment, the waveguide 102 is 100 micrometers wide (in the plane of the figure) and 1 micrometer thick (perpendicular to the plane of the figure)

The SAW transducers 110 are each driven by an RF drive signal that creates a corresponding surface acoustic wave 140. The surface acoustic wave 140 counter-propagates collinearly with the light in the waveguide 102. The SAW interacts with the light, both near the proximal face 160, to diffract and convert part of the light to a transverse magnetic (TM) polarization, leaky mode.

Here, the SAW transducers are interdigital transducers that are approximately 1 mm long (i.e., in the direction of the waveguide 102) and have features on the order of 1-10 micrometers. IDT pads 128A, 128B are each roughly 300 micrometers×300 micrometers. As is well-known in the field of IDT design, the DT finger spacing is a function of center frequency; or, if a range of operational frequencies is desired, the range of IDT finger spacings is in part determined by the center frequency and bandwidth.

The RE drive signals are generated by the control module 100 and are delivered to the IDT pads 128A, 128B by conductive electrical traces or wirebonds, which are not shown. One approach for the delivery of the electrical drive signals is described in U.S. patent application Ser. No. 15/891,828, entitled “Packaging and Interconnect Systems for Edge-Emitting Light Modulators,” filed on Feb. 8, 2018, by Favalora, et al., and incorporated herein by this reference.

Typically, electrical signals are in the range of 200-400 MHz but can be as expansive as DC −3 GHz, and have a power of about 300 mW, but could possibly span 1 mW-10 W.

Birefringence of the waveguide 102 and the SAW substrate 120 causes the TM leaky mode portion of the light propagating in the waveguide 102 to leak out of the waveguide 102 into the SAW substrate 120. The leaky mode portion of the light enters the substrate 120 as diffracted light 162, which travels within the substrate 120 towards an exit face. Here, the exit face is an end face 170 of each SAW substrate 120 of each light field generator device 300-1, 300-2.

In different embodiments, the IDT 110 can occupy a variety of specific locations and specific orientations with respect to the waveguides 102. For example, in the illustrated embodiment, the transducers 110 are located near the end face 170 so that the surface acoustic waves 140 will propagate in a direction opposite the propagation of the light in the waveguides 102. In other embodiments, however, the transducers 110 are located near the in-coupling devices 106 so that the surface acoustic waves 140 will co-propagate in the direction of the light in the waveguides 102.

Also, there could be multiple SAW transducers 110 for each in-coupling device 106/waveguide 102. In such an implementation, each SAW transducer 110 might be responsible for a different specific bandwidth around a given center frequency (e.g.: 100-200 MHz, 200-300 MHz, and 300-400 MHz).

In a specific embodiment, the array 202 of SAW optical modulators 200 may be packed relatively tightly with a waveguide separation 206 of between 10 μm-400 μm, for example, 50 μm. The waveguide length WL may be less than a centimeter to several centimeters (e.g., 1 cm) long.

FIG. 1B shows a side view illustrative of the operation of an exemplary SAW modulator 200 of the light field generator device 400. It shows a side facet 156 of the SAW substrate 120.

In terms of the SAW modulator operation, the input light signal 101 from the control module is coupled into the prisms 106. The optical signal is then coupled into the waveguide 102.

At the other end of the SAW modulator device 200, the IDT 110 generates the surface acoustic wave 140 that counter propagates with the light in the waveguide 102. When they interact, see point I, the surface acoustic wave 140 diffracts the optical signal 101 to create diffracted light 162 that leaks out of the waveguide 102 at angle φ, measured from grazing.

In the illustrated embodiment, the diffracted light 162 exits the substrate 120 via end face 170 as the exit face, at angle θ. When the diffracted light 162 exits the substrate 120 into air, for example, the edge cut angle β in combination with the refraction at this interface causes the exit light 150 to propagate in a direction that is generally parallel to the longitudinal axes of the SAW devices 200 and parallel to the plane 126 of the proximal faces 160 of those devices 200, in the illustrated example. Thus, in this example, angle θ varies from negative to positive.

Traces or wirebonds 111 are used to deliver RF signals from the control module 100 to the IDTs 110 of the SAW devices 200.

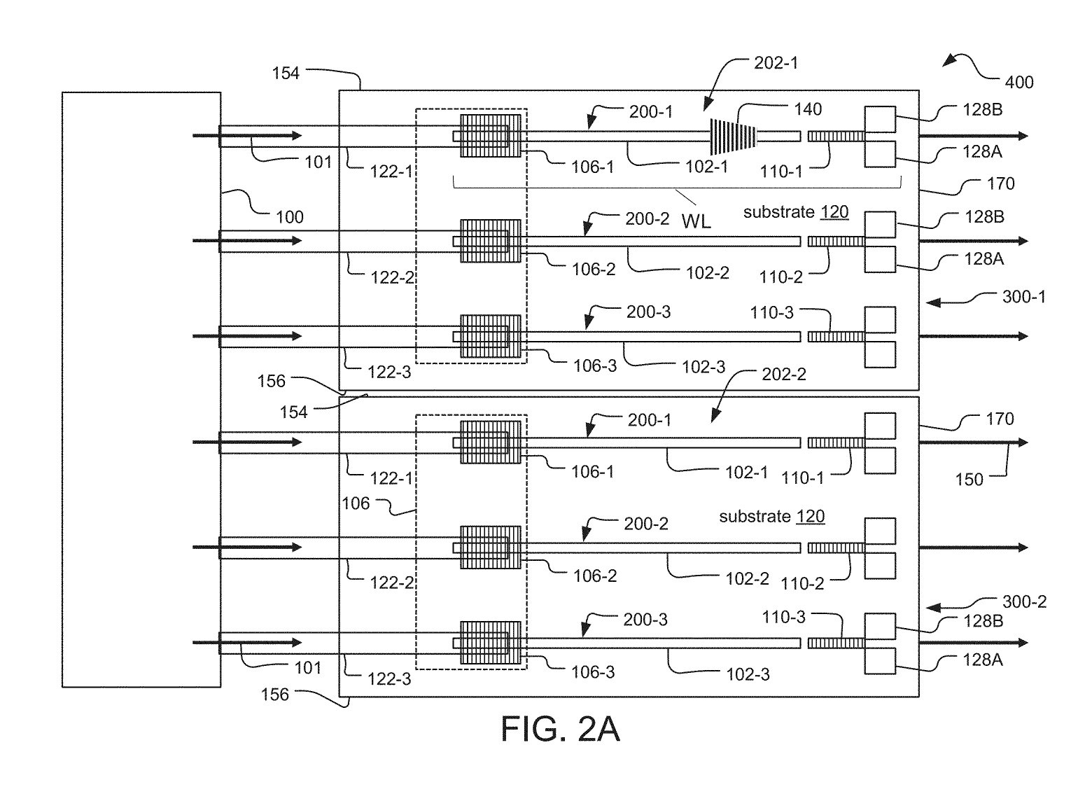

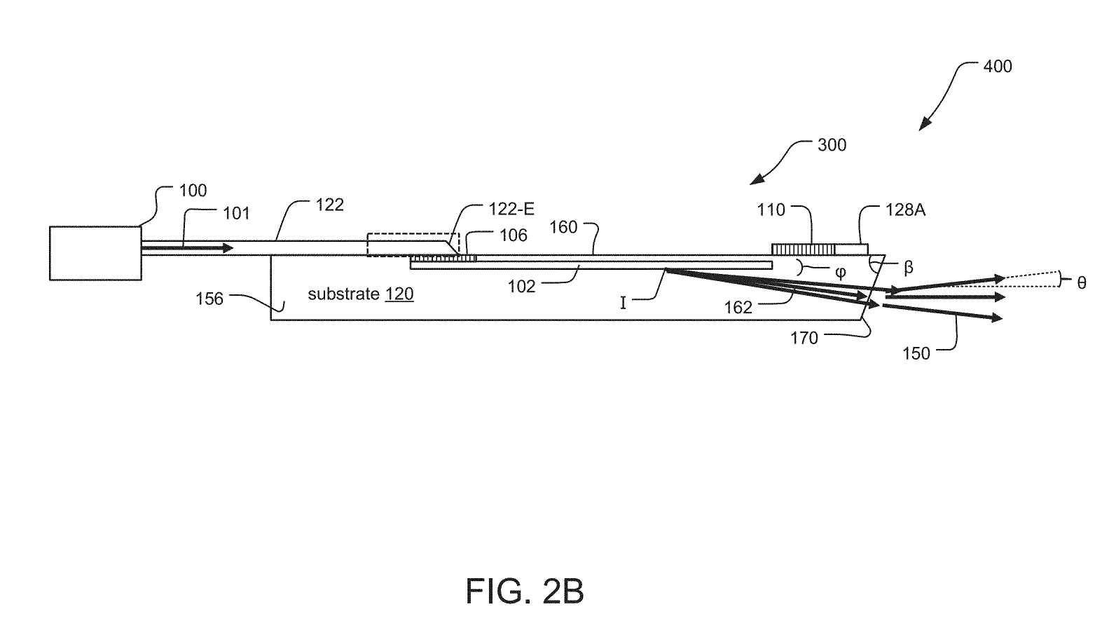

FIG. 2A shows another example. Here, the in-coupling device 106 is a series of gratings. Each grating receives input light 101 from the control module 100 via an optical fiber pigtail 122 that terminates above the respective grating 106.

FIG. 2B shows a side view. The input light signal 101 is carried to the device from the control module via the optical fiber pigtail 122. In the illustrated embodiment, end 122-E of the optical fiber pigtail 122 is polished at an angle and preferably metallized or coated with another reflective coating. Thus, the optical signal 101 transmitted by the pigtail 122 is reflected at the end 122-E toward the in-coupling grating 106 of the SAW modulator device 200. As a result, the optical signal is coupled into the waveguide 102 via the grating 106.

In some examples, the optical fiber pigtails 122 are arranged on and bonded to the surface of the substrate 120. In other cases, the pigtails are placed such that they lie on or within trenches formed into the proximal face 160 of the SAW substrate 120. In more detail, a fiber, whose light is focused at least in one axis by a lens, is directed at the narrow input edge of the substrate at a defined angle. The input edge will probably be polished at an angle to assist the efficient delivery of light.

A variety of fiber-coupling technologies are well-known, as summarized for example in: Jun Su Lee, et al, “Meeting the Electrical, Optical, and Thermal Design Challenges of Photonic-Packaging, “IEEE J of Selected topics in Quantum Electronics, 22(5), 8200209 (November/December 2016).

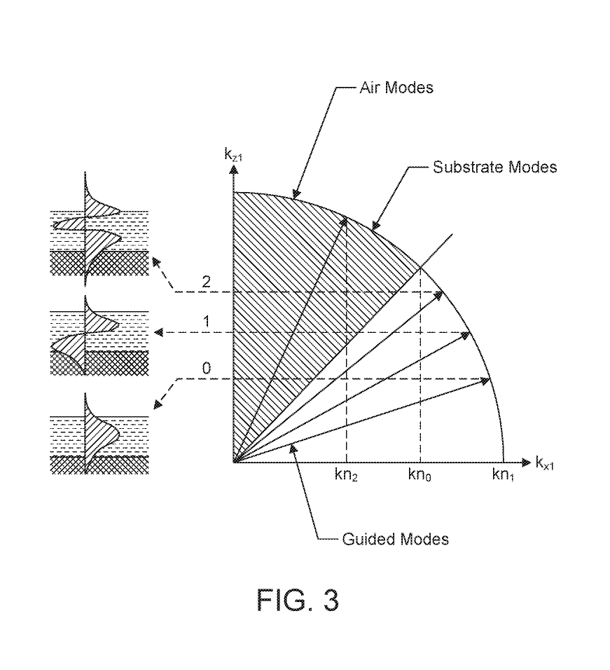

As background, FIG. 3 is based on a similar figure in an article: P. K. Tien, “Light Waves in Thin Film and Integrated Optics,” Applied Optics, 10(11), 2395-2413 (November 1971) (See pp 2398-2399).

Here, the radii of the illustrated quarter-circle represent possible directions of the wave vector. In the first region of the circle, the wave vector represents the substrate or air mode. In the second region of the circle, the wave vector represents the waveguide mode.

Only a discrete set of directions in this second region satisfy the equation of the waveguide modes. Each direction of this discrete set represents one wave guide mode and each waveguide mode has its own field distribution as shown on the left side.

The field distributions (shown on the left side of the figure) correspond, in the context of this description, to TE-like modes, which are referred to here as TE modes. TE refers to modes with the electric field is in the plane of the modulator.

For definition: k=2 Pi*n/lambda, where n is the material index for waves propagating in the bulk of a material or the effective index of the propagating mode in a waveguide; and lambda is the free-space wavelength.

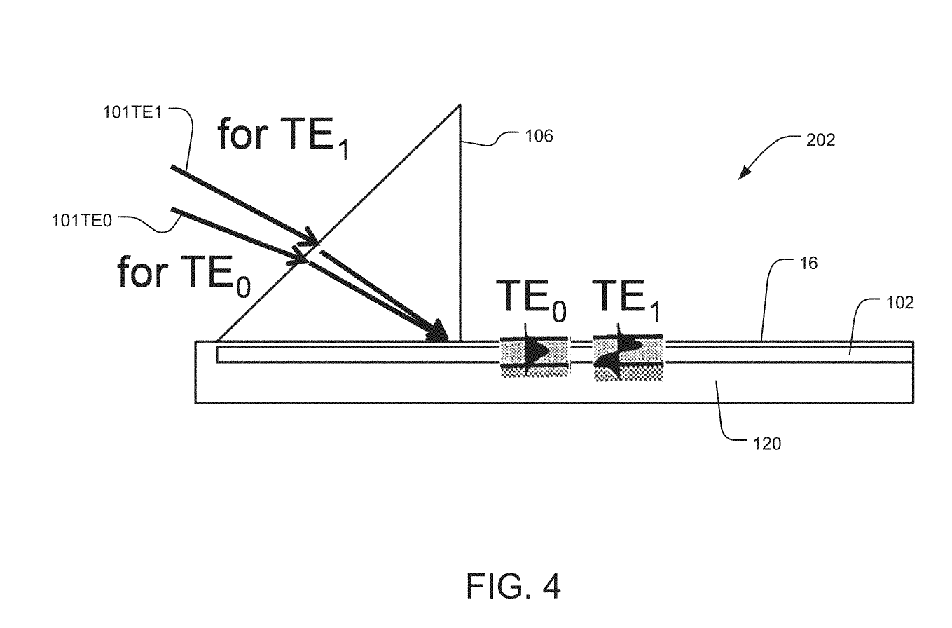

FIG. 4 relates the diagram of FIG. 3 to the structure of a modulator 200 with a waveguide 102. It illustrates schematically a typical relationship between the angle of illumination and the TE modes that are correspondingly excited in the waveguide 102 of the modulator 200.

Each of the guided modes (e.g. TE0, TE1, TE2) has an in-plane momentum, or propagation constant, associated with it (denoted by k×1 in FIG. 3). The input light 101 can only couple to a specific guided mode if its own in-plane momentum matches that of the mode. The in-plane momentum of the input light is determined by the refractive index of the prism in-coupling device 106 and the input light's input angle. By varying the angle, the in-plane momentum of the input light 101 can be adjusted until it matches that of the guided mode of interest. In this way, specific modes (e.g. TE0, TE1, TE2) can be selectively excited by changing the input angle of input light, see 101 TE0 and 101 TE1.

Once coupled into a specific guided mode, the light can then interact with a SAW that acts like a diffraction grating, adding or subtracting from the in-plane momentum of the guided mode, changing its properties including its angle of propagation.

There exists a different set of modes that are not completely confined to the waveguide, called “leaky modes.” (Generally, leaky modes have a different polarization than the guided modes, i.e. that there is a TE-TM conversion when the guided modes interact with and are diffracted by the SAW.) These modes leak out of the waveguide 102 and can be observed in the far field.

In contrast to the guided modes, the leaky modes do not exist at discrete spots in momentum space. The leaky modes form a continuum and exist over a large range of in-plane momentum values, each having slightly different profiles and propagation characteristics. The guided modes can couple to these leaky modes when they are perturbed by something such as a scattering event, a diffraction event (i.e., diffracted by the SAW 140), and/or a change in refractive index. The specific leaky modes, to which a guided mode couples, depend on the similarity between the guided and leaky modes, namely the overlap of their field profiles, and the change in momentum imparted on the guided mode. The propagating SAW 140 perturbs the guided mode by slightly altering the dielectric permittivity in the waveguide 102, causing it to couple with a subset of the leaky modes and altering its in-plane momentum. The angle at which this leaky mode exits into the substrate depends on its in-plane momentum, which is dependent on the frequency of the SAW 140.

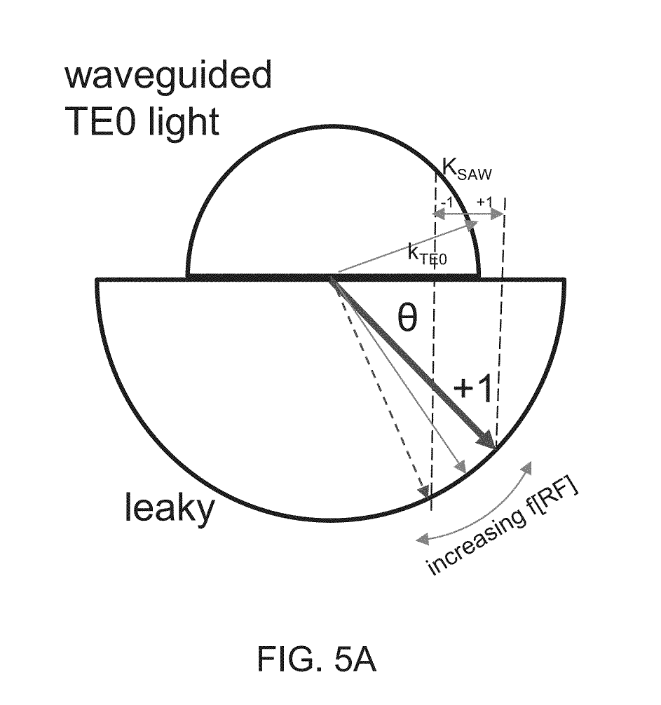

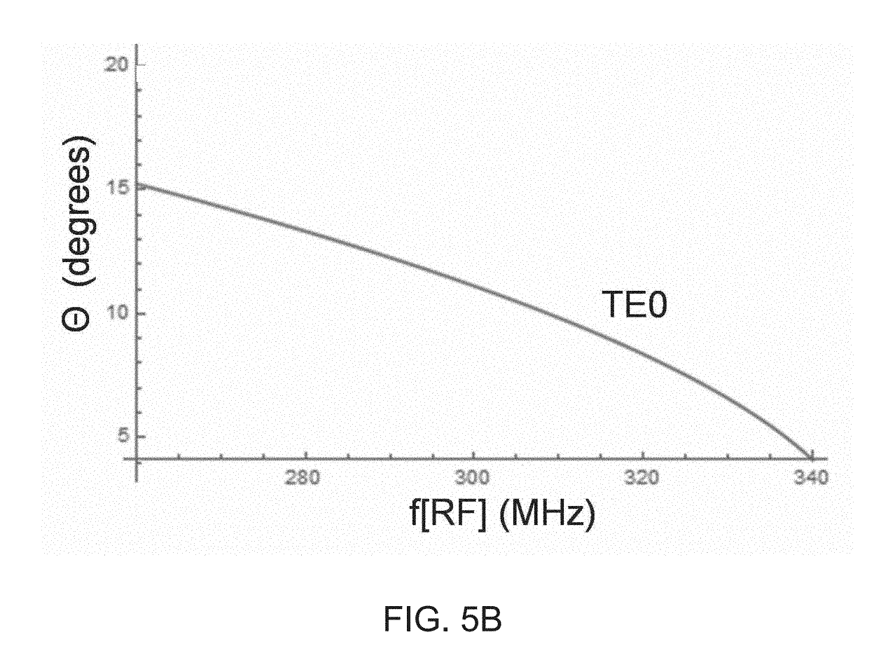

FIG. 5A depicts a wave vector diagram, as is used in the field of integrated optics. The radii of the semicircles are proportional to the index of refraction (top: waveguide; bottom: leaky mode). The vector k[TE0] represents the grating created by the SAW, via vector K[SAW]. Here, both diffractive orders −1, +1 are shown. The resulting light leaks out of the waveguide and, due to the index change between the waveguide and substrate, has a new trajectory indicated by the solid arrow labeled “±1” at angle θ. Also shown is the trajectory associated with the −1 order. As the RF frequency applied to the SAW transducer increases, K[SAW] increases (the spatial frequency decreases), and θ decreases (the light propagates within the substrate closer to grazing). Also depicted is the impact of the −1 diffractive order, whose behavior is opposite: θ for the −1 order increases with increasing RF frequency.

FIG. 5B shows the behavior of the +1 diffracted ray as a function of RF drive frequency.

Note that angle θ is shown in FIG. 1A. It refers to the angle of the light exiting from the substrate 120. These plots are for an edge cut angle β of 90 degrees, with the light exiting into air.

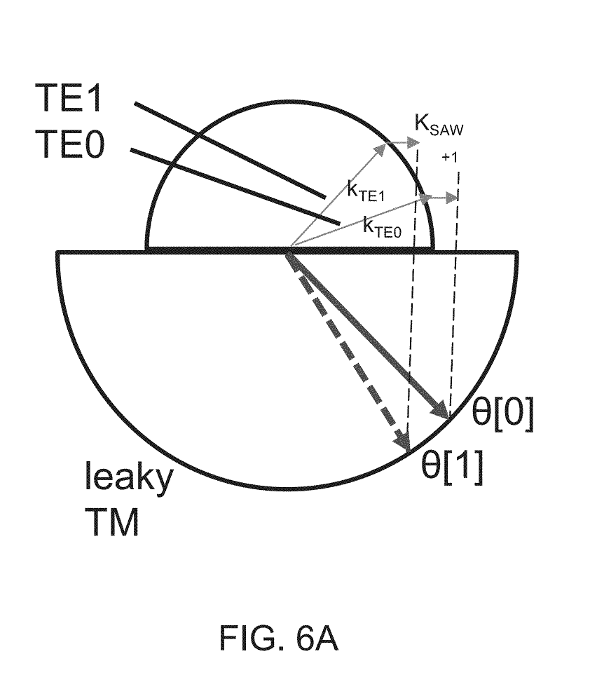

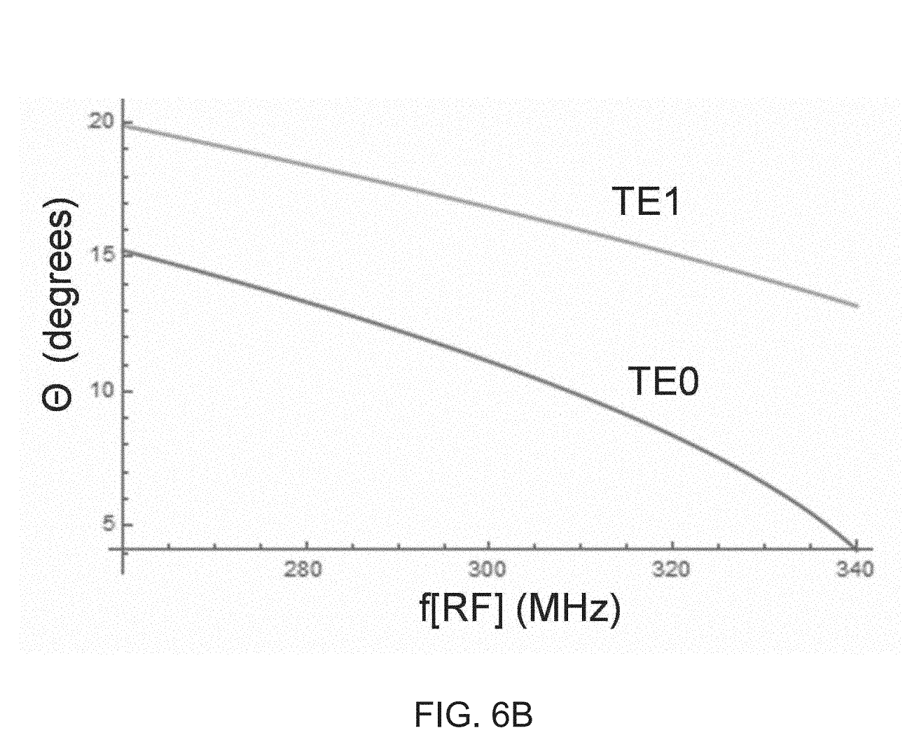

FIGS. 6A and 6B extend this example for the case of two different waveguide modes: TE0 and TE1. In this case, the index of TE0>the index of TE1. As such, the angle of the leaky mode light is different for the two waveguide modes.

It is important to note that the difference between the substrate index and the waveguide index (indices) depends on the details of waveguide fabrication. For example, here the scenario in which n[SUBSTRATE]>n[WAVEGUIDE] where the E-field of light propagating in the waveguide is parallel to the extraordinary axis (TE polarized) and leaky mode light has the E-field perpendicular to the extraordinary axis (TM polarized). However, in other cases, n[SUBSTRATE]<n[WAVEGUIDE].

One way to visualize these factors is in a “datamap,” as described in the (Smalley et al, 2015) reference.

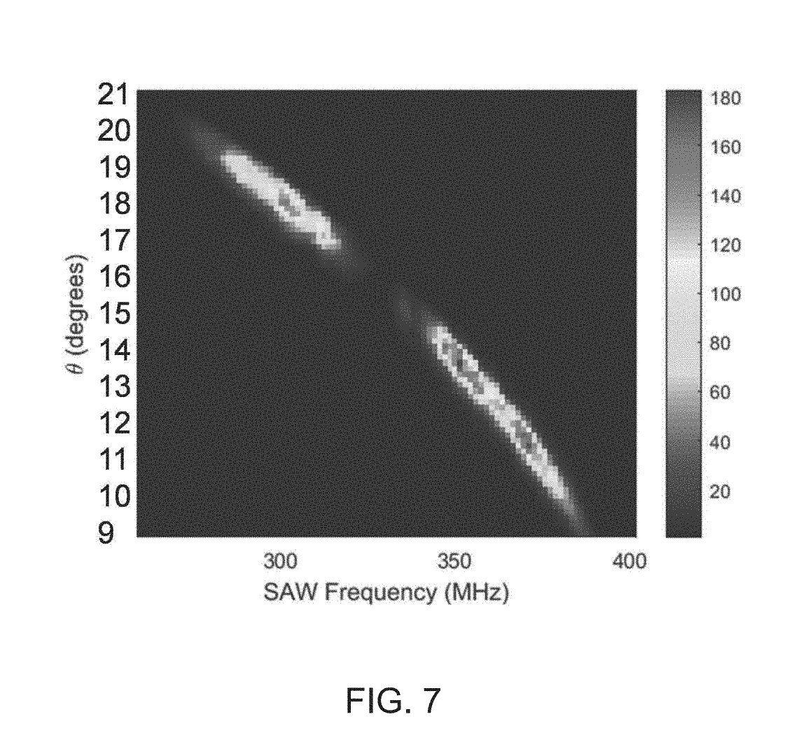

FIG. 7 illustrates a datamap for a specific modulator. It had a reverse proton exchanged waveguide in x-cut, y-propagating lithium niobate, in which the waveguide width (in the z direction) is 100 microns, the waveguide depth is approximately 1 micrometer, and the extent of the waveguide in the x direction is approximately 1 micrometer. The plot shows the angle of the exit light as a function of SAW frequency/frequency of the RF drive signal for the TE1 guided mode. The IDT is designed according the well-known methods to be responsive to activation in the frequency range depicted, i.e. approximately 250 MHz to 400 MHz. The datamap thus shows output light being scanned, has an exit angle fan of, approximately 11 degrees, being the difference between 9 and 20 degrees from grazing.

The measured intensity is relatively lower in the interval from about 14 to 16 degrees. In some applications, this is undesirable. It is preferable to remedy this “drop-out” in the exit angle fan.

Several factors influence the intensity as a function of drive signal frequency. These include: the IDT response (electrical to mechanical coupling efficiency) as a function of input frequency, field profile overlap between the TE guided mode and the leaky TM mode continuum, the magnitude of the waveguide perturbation induced by the SAW (manifested in the change in the dielectric permittivity matrix), the overlap of the mode field profiles with the SAW-induced waveguide perturbation, and of the material's acousto-optic coupling parameters.

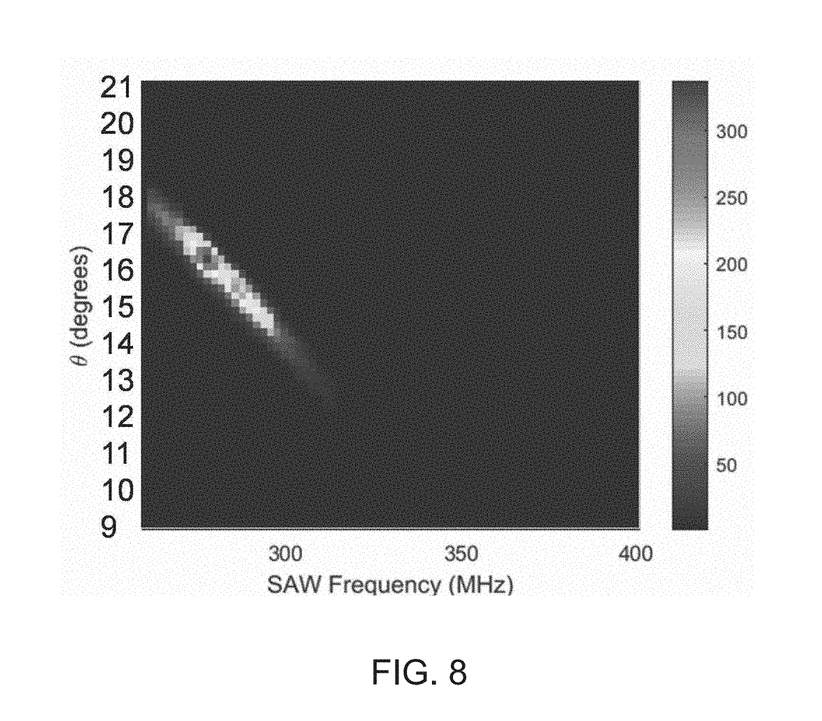

FIG. 8 shows a datamap of the same modulator channel, but to TE0, rather than TE1, input illumination. In this case, there is a peak in output leaky-mode light from approximately 14 to 17 degrees from grazing, providing 3 degrees of exit angle fan.

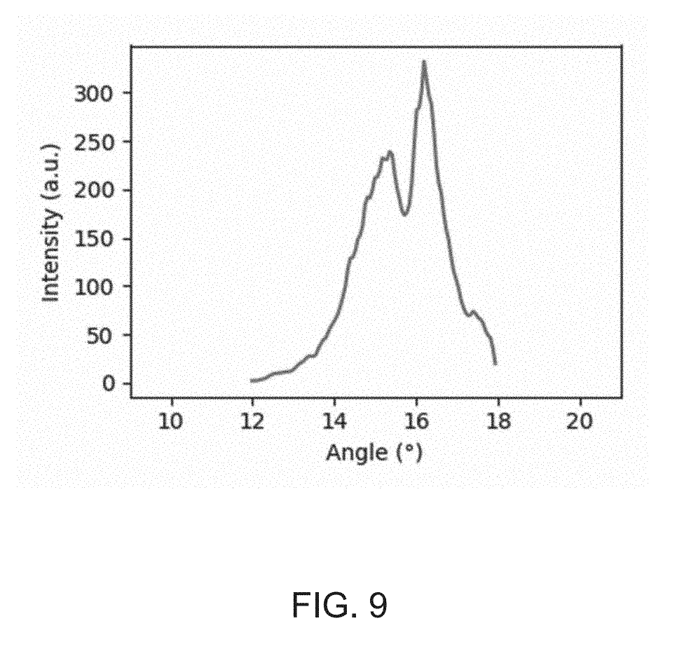

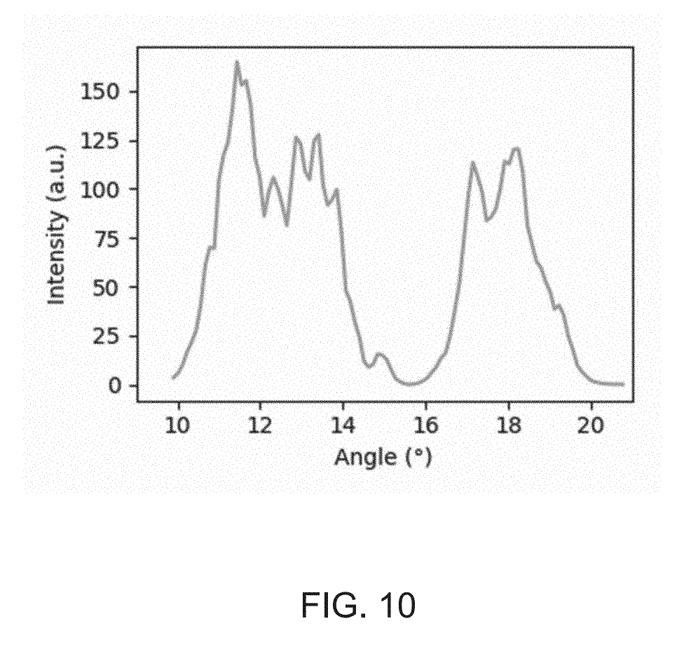

FIGS. 9 and 10 show the exit angle and intensity, which are convenient depictions for the engineering of practical light field generators.

To solve the problem of uneven and/or discontinuous intensity as a function of angle, one or more SAW modulators are used, in which light in the waveguides of the SAW modulators are able to propagate in at least two guided modes. Then, the guided modes are selectively diffracted from the waveguides. Thus, the TE-mode-dependent responses can be exploited to improve, e.g. flatten, the intensity of the modulator with respect to angle. In particular, it can be used to improve a continuity of an exit light fan from SAW modulators.

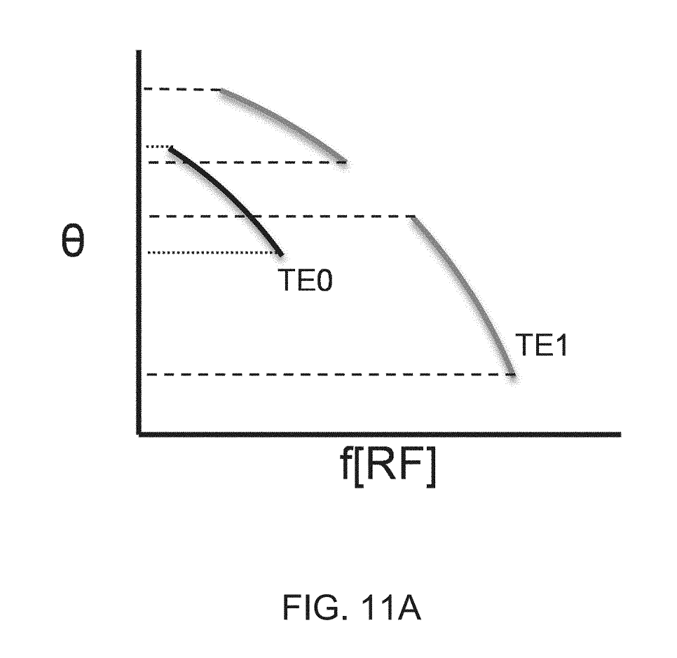

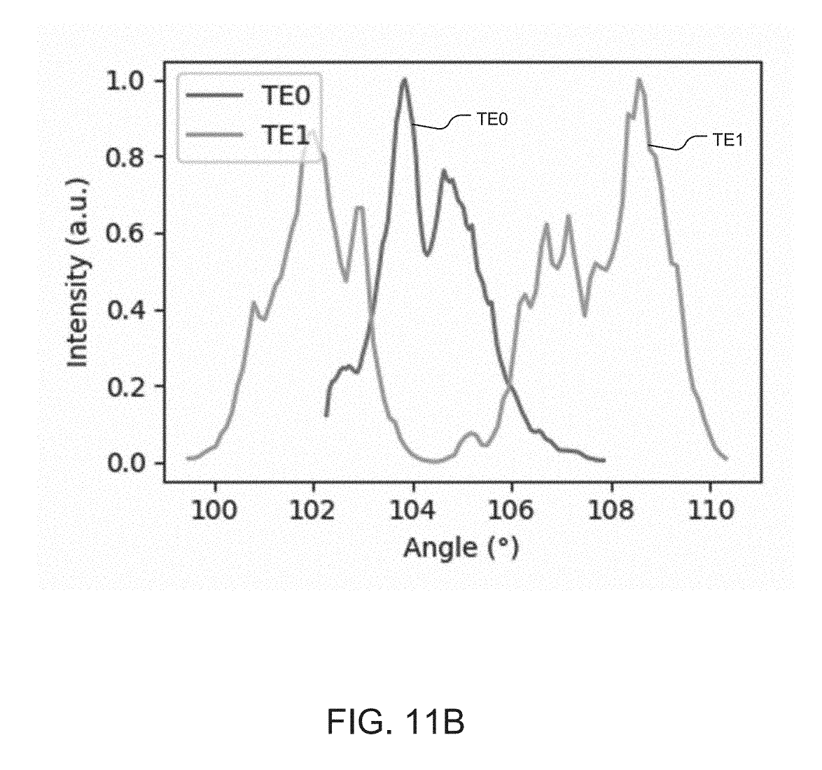

FIGS. 11A and 11B overlay the previous data. They illustrate how exit angle dropout can be reduced or eliminated by exploiting the TE0 and TE1 modes.

In more detail, FIG. 11A is a schematic plot showing the angle of the exit light as a function of SAW frequency/frequency of the RF drive signal for both the TE0 and TE1 modes. The dropout in the exit light fan of the TE1 mode can be patched with the exit light fan of the TE0 mode.

FIG. 11B shows the same information in a different way. Specifically, it plots intensity as a function of angle for both the TE0 and the TE1 modes. A continuous and flat exit light fan can be achieved by controlling how the guided modes are diffracted from the waveguides and by modulating the optical power in the TE0 and the TE1 modes.

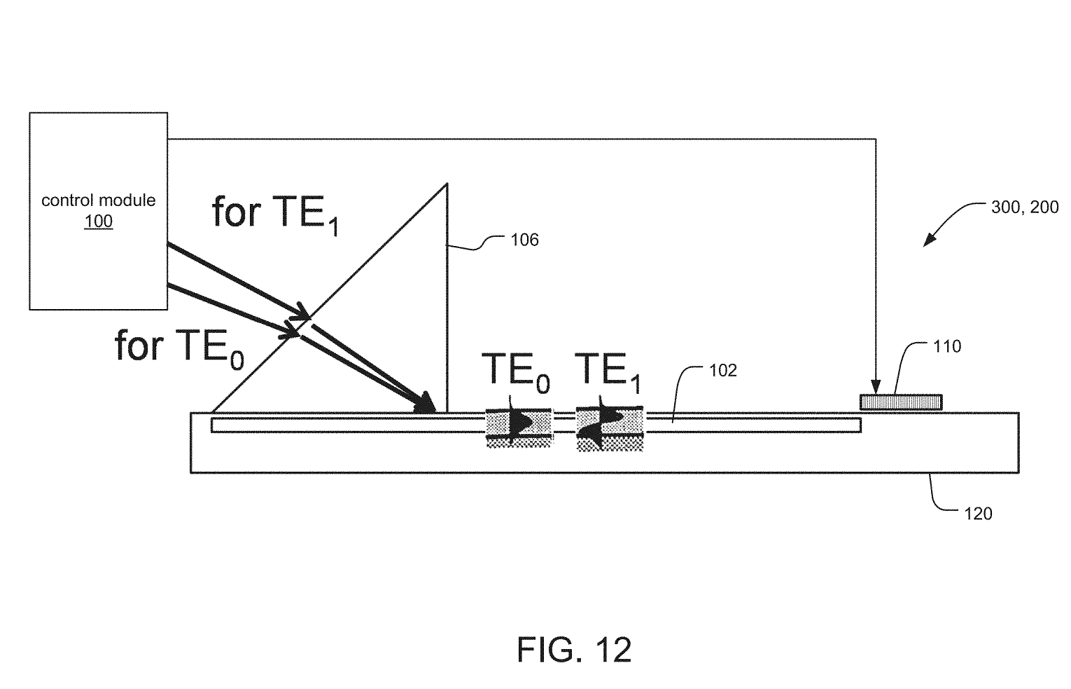

FIG. 12 depicts a light field generator device 300 and shows one of its SAW modulators 200. The waveguides are concurrently excited with more than one transverse mode, TE0 and TE1, by the controller module 100. At the same time, the controller module 100 generates a RF drive signal to the SAW transducers 110 so that the guided modes are selectively diffracted from the waveguides.

The RF drive signal is swept in frequency so that every angle within the device's range will be emitted. Thus, dropout in the exit angle fan is avoided.

It should be noted, however, the operation of this embodiment might be a drawback for some applications: at some frequencies, light will exit the modulators 200 at more than one angle at a time.

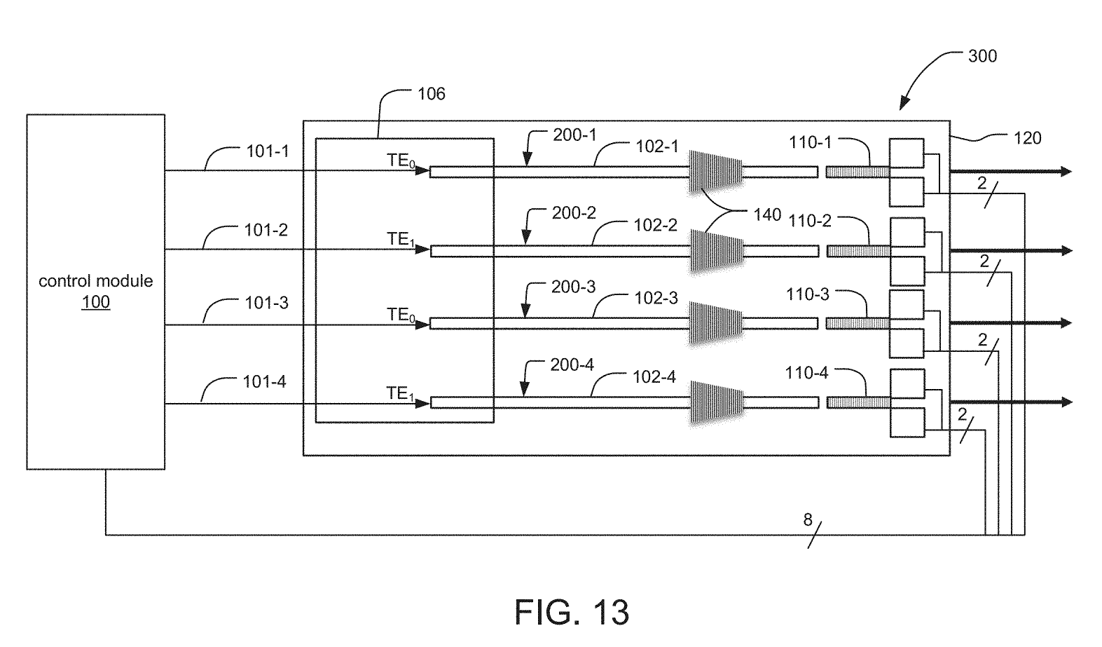

FIG. 13 depicts a light field generator device 300 in which the waveguides 102-1 to 102-4 of SAW modulators 200-1 to 200-4 are spatially multiplexed, as to avoid the problem of the previous structure. Here, the controller module 100 delivers light to the waveguides 102-1 to 102-4 via one or more in-coupling devices 106 so that different guided modes are excited in different waveguides.

In the illustrated example, TE0 mode is excited in the first and third waveguides 102-1, 102-3 of the first and third SAW modulators 200-1, 200-3 of the light field generator device 300. Whereas, the TE1 guided mode is excited in the second and fourth waveguides 102-2 and 102-4 of the second and fourth SAW modulators 200-2, 200-4.

At the same time, the controller module 100 delivers RF drive signals to the SAW transducers 110-1 to 110-4 of the SAW modulators 200-1 to 200-4 to drive the IDTs corresponding to the waveguide propagating TE0 light with a different signal than the IDT designated for the waveguide propagating TE1 light. In the extreme case, the controller module 100 delivers a different RF signal to each of the SAW transducers 110-1 to 110-4 based on the frequency of light and the guided mode in the corresponding waveguide 102, and the desired output light (angle and intensity) required for the corresponding waveguide. In this way, the controller module selectively diffracts the guided modes from the waveguides.

In many applications, such as electro-holographic display, this spatial multiplexing is acceptable. For example, if the output ports are spaced at 1 millimeter for a viewer at 1 meter, there should be little image degradation from the standpoint of the viewer due to the spatial multiplexing.

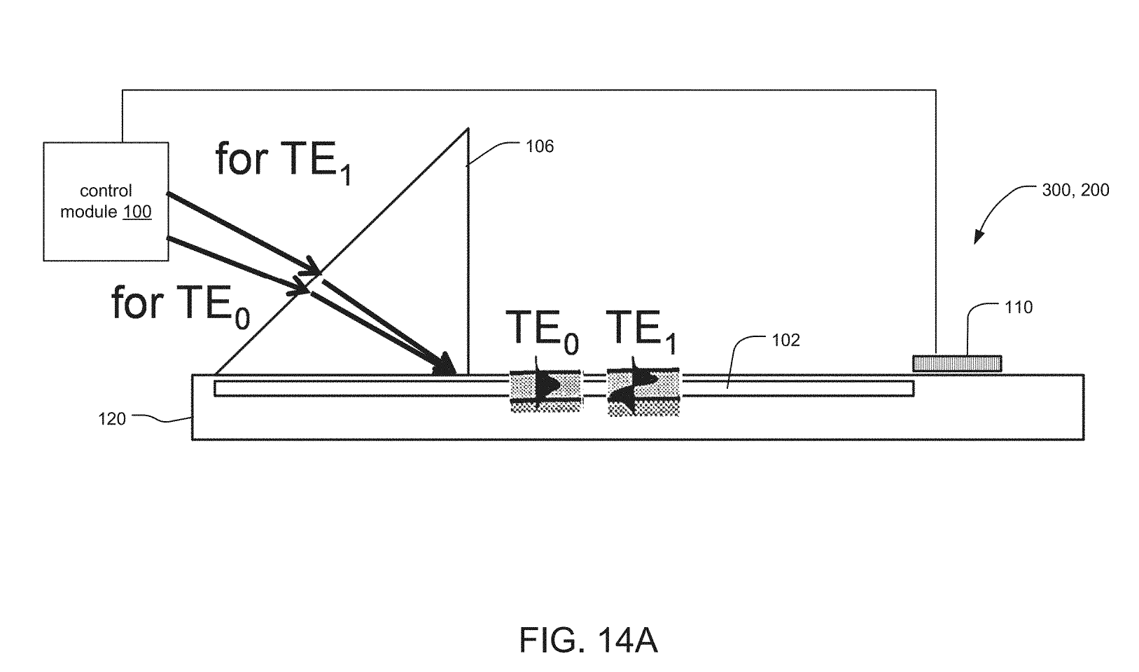

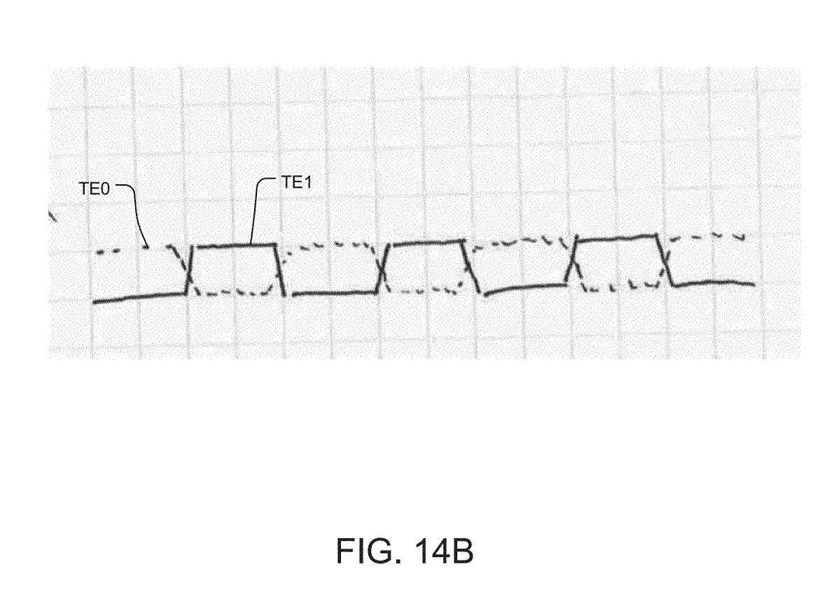

FIGS. 14A and 14B depict a time-, rather than space-multiplexed arrangement. In this case, the controller module 100 time multiplexes the excitement of the guided modes, such as time multiplexing TE0 and TE1 guided modes in each of the waveguides of the light field generator device. Synchronously, the controller module 100 delivers RF drive signals to the SAW transducers 110 so that the TE0 RF drive signal diffracts the TE0 mode when the waveguide is excited with that mode, and the TE1 RF drive signal diffracts the TE1 mode when the waveguide is excited with that mode. In this way, the controller module selectively, diffracts the guided modes from the waveguides.

In should be noted that while the present discussion centers around the control of the TE0 and TE1 modes, the principles here could be applied to other sets of modes and other multiplexing arrangements, using various combinations of guided modes, e.g. TE0, TE1, TE2, TE3, TE4, etc.

In general, the controller module 100 amplitude modulates the applied the RF drive signals in order to provide a useful mapping between input light amplitude and output light intensity required to generate the desired light field. For example, the module will boost the RE drive signal and/or the input for frequencies corresponding to “dim” output angles.

FIG. 14B is a plot showing the optical power in each of the guided modes in the waveguide 102 as a function of time. As shown, the waveguide 102 is excited with each of the transverse modes TE0, TEO in an alternating fashion.

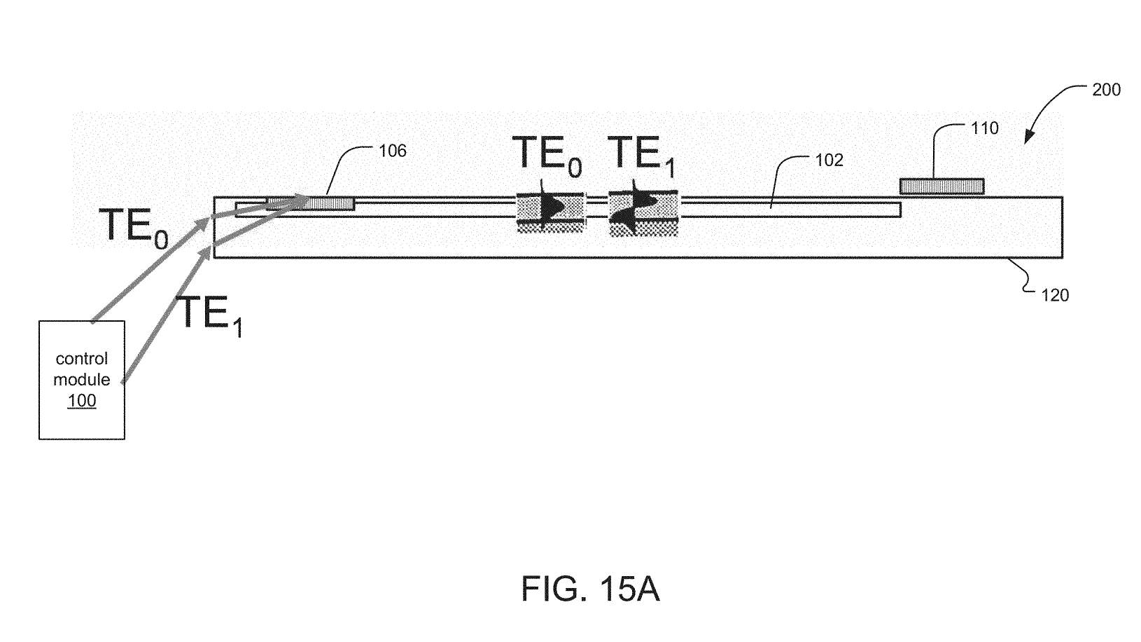

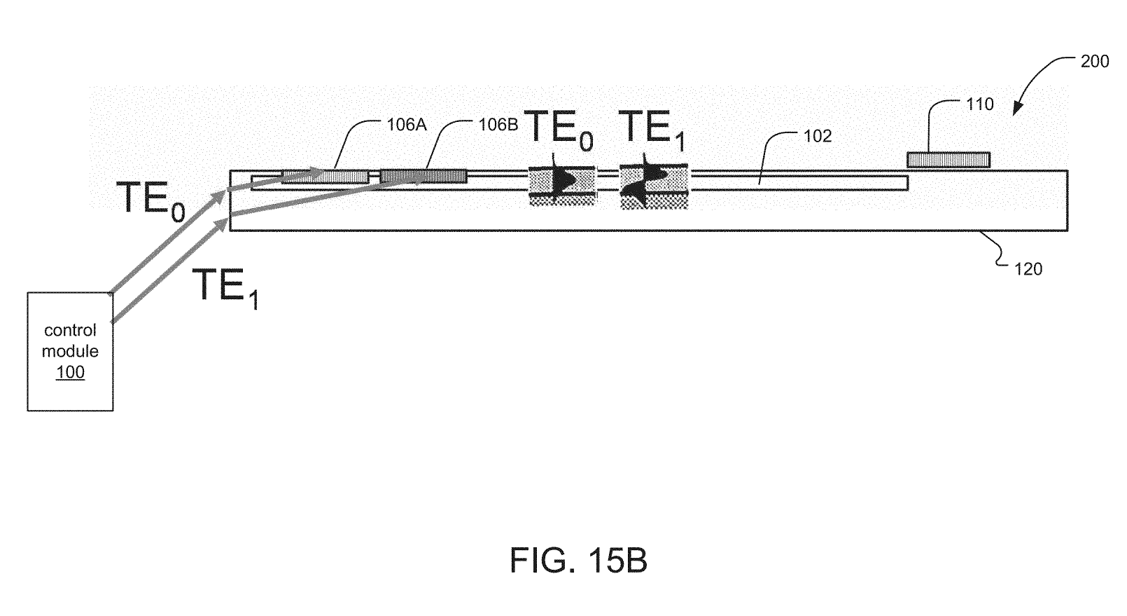

FIGS. 15A and 15B depict SAW modulators in which the in-coupling devices are gratings 106.

In general, there are two different methods for coupling into different propagating modes using gratings. One option is to have light incident on the same grating at different angles as show in FIG. 15A. Different incidence angles will allow coupling into propagating modes in the waveguide that have different k-vectors. The second option is to design different gratings 106A, 106B, such that the same incidence angle of light can be used as shown in FIG. 15B. Each grating 106A, 106B will be designed to couple light into a specific mode at the given designed incidence angle.

Having the option to use the same incidence angle to couple light into different modes can be advantageous in modulator applications because different modes can then be selected without changing the incidence angle of light on the device.

While this invention has been particularly shown and described with references to preferred embodiments thereof, it will be understood by those skilled in the art that various changes in form and details may be made therein without departing from the scope of the invention encompassed by the appended claims. For example, it should be noted that SAW modulators can be arranged to principally rely on light emitting from a narrow end face (“Edge-Fire”) or from a broad distal face (“Face-Fire”). The illustration s in the present disclosure depict Edge-Fire architectures but the invention applies to Face-Fire as well.

1. A surface acoustic wave (SAW) modulator system, comprising:
one or more SAW modulators in which light in waveguides of the SAW modulators propagates in at least two guided modes, the guided modes being selectively diffracted from the waveguides by surface acoustic waves.

2. A system as claimed in claim 1, wherein light in each of the waveguides propagates in at least two guided modes.

3. A system as claimed in claim 1, wherein the light propagates in at least two guided modes simultaneously.

4. A system as claimed in claim 1, wherein the light propagates in at least two guided modes serially in time.

5. A system as claimed in claim 1, wherein the system comprises multiple SAW modulators and different waveguides of the SAW modulators propagate different guided modes.

6. A system as claimed in claim 1, further comprising a controller that controls the delivery of drive signals to SAW transducers of the SAW modulators to improve a continuity of an exit light fan from the SAW modulators by selectively diffracting the guided modes.

7. A system as claimed in claim 1, further comprising in-coupling devices for delivering light to excite the at least two guided modes in the waveguides.

8. A surface acoustic wave (SAW) modulator system, comprising:
one or more SAW modulators in which light in waveguides of the SAW modulators propagates in at least two guided modes, the guided modes being selectively diffracted from the waveguides by surface acoustic waves; and
in-coupling devices for delivering light to excite the at least two guided modes in the waveguides;
wherein the in-coupling devices include in-coupling prisms for receiving light at different angles to excite the at least two guided modes in the waveguides.

9. A surface acoustic wave (SAW) modulator system, comprising:
one or more SAW modulators in which light in waveguides of the SAW modulators propagates in at least two guided modes, the guided modes being selectively diffracted from the waveguides by surface acoustic waves; and
in-coupling devices for delivering light to excite the at least two guided modes in the waveguides;
wherein the in-coupling devices include multiple in-coupling gratings for each of the waveguides, each grating for exciting a different guided mode of the respective waveguide.

10.-18. (canceled)

19. A surface acoustic wave (SAW) modulator system, comprising:
a substrate;
waveguides in the substrate;
in-coupling devices for coupling light into the waveguides so that different guided modes of the waveguides are excited;
SAW transducers for generating surface acoustic waves in the substrate;
a controller that delivers drive signals to SAW transducers based on the guided modes in the waveguides.

20. A system as claimed in claim 19, wherein the SAW transducers are interdigital transducers.

21. A system as claimed in claim 19, wherein the surface acoustic waves convert part of the light in the waveguides to a different polarization, which is a leaky mode, wherein the light that has been converted to the different polarization leaks out of the waveguides and into the substrate and exits out of an exit face of the substrate.

22. A system as claimed in claim 19, further comprising an array of three of the waveguides in the substrate.

23. A system as claimed in claim 19, wherein the substrate is lithium niobite.

24. A system as claimed in claim 19, wherein the in-coupling devices include in-coupling prisms for receiving light at different angles to excite the different guided modes in the waveguides.

25. A system as claimed in claim 19, wherein the in-coupling devices include multiple in-coupling gratings.

26. A system as claimed in claim 19, wherein the in-coupling devices include multiple in-coupling gratings for each of the waveguides, each grating for exciting a different guided mode of the respective waveguide.

27. A system as claimed in claim 19, wherein a separation between the waveguides is less than 400 μm.

28. A system as claimed in claim 1, further comprising a controller that controls the delivery of drive signals to SAW transducers of the SAW modulators to increase an exit angle fan.
